(19) United States
(12) Patent Application Publication
(10) Pub. No.: US 2026/0198588 A1
(43) Pub. Date: Jul. 16, 2026

(54) AEROSOL PROVISION SYSTEM

(71) Applicant: Nicoventures Trading Limited, London (GB)

(72) Inventors: Gary FALLON, London (GB); Paul GIBSON, London (GB)

(21) Appl. No.: 19/138,985

(22) PCT Filed: Dec. 14, 2023
(86) PCT No.: PCT/GB2023/053227

§ 371 Date: Jun. 13, 2025

(30) Foreign Application Priority Data
Dec. 15, 2022 (GB) 2218990.6

(51) Int. Cl. A24F 40/465; A24F 40/44; A24F 40/46; A24F 40/48; A24F 40/70; H05B 3/20

(52) U.S. Cl. CPC A24F 40/465; A24F 40/44; A24F 40/46; A24F 40/48; A24F 40/70; H05B 3/20

(57) ABSTRACT

An aerosol generating component for use as part of an aerosol provision system. The aerosol generating component defines an axis and comprises a plurality of generally planar heating sections. The heating sections are arranged along the axis defined by the aerosol generating component and spaced apart from each other. The plane of each heating section is obliquely angled with respect to the axis defined by the aerosol generating component.

### CROSS-REFERENCE TO RELATED APPLICATIONS

This present application is a National Phase entry of PCT Application No. PCT/GB2023/053227, filed 14 Dec. 2023, which claims priority from Great Britain Application No. 2218990.6, filed 15 Dec. 2022, each of which are fully incorporated herein by reference in their entireties.

### FIELD

The present invention relates to an aerosol generating component for use as part of a non-combustible aerosol provision system, an article comprising the aerosol generating component, a non-combustible aerosol provision system comprising the article, and a method of manufacturing the aerosol generating component.

### BACKGROUND

Non-combustible aerosol provision systems that generate an aerosol for inhalation by a user are known in the art. Such systems typically comprise an aerosol generating component which is capable of converting an aerosolisable material into an aerosol. In some instances, the aerosol generated is a condensation aerosol whereby an aerosolisable material is first vaporised and then allowed to condense into an aerosol. In other instances, the aerosol generated is an aerosol which results from the atomisation of the aerosolisable material. Such atomisation may be induced mechanically, e.g. by subjecting the aerosolisable material to vibrations so as to form small particles of material that are entrained in airflow. Alternatively, such atomisation may be induced electrostatically, or in other ways, such as by using pressure.

Since such aerosol provision systems are intended to generate an aerosol which is to be inhaled by a user, consideration should be given to the characteristics of the aerosol produced. These characteristics can include the size of the particles of the aerosol, the total amount of the aerosol produced, etc.

Where the aerosol provision system is used to simulate a smoking experience, e.g. as an e-cigarette or similar product, control of these various characteristics is especially important since the user may expect a specific sensorial experience to result from the use of the system.

It would be desirable to provide aerosol delivery systems which have improved control of these characteristics.

### SUMMARY

According to a first aspect of the present disclosure, there is provided an aerosol generating component for use as part of an aerosol provision system, the aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component.

The present inventors have discovered that by virtue of the obliquely angled heating sections, the aerosol generating component can be configured to effectively control the direction of airflow in use. For example, the aerosol generating component may be configured to drive airflow to a particular location or component in use. By controlling the airflow in use, improvements in aerosol generation and/or aerosol properties have been observed.

In one aspect, the axis defined by the aerosol generating component is selected from: the longitudinal axis of the aerosol generating component, the transverse axis of the aerosol generating component, and the axis of the aerosol generating component along which air flows in use.

In one aspect, the heating sections comprise a series of heating sections. In one aspect, the series of hearing sections are obliquely angled with respect to the axis defined by the aerosol generating component towards a direction. In one aspect, the series of heating sections are arranged to divert airflow in the direction in use. The direction may be towards an end of the aerosol generating component. The direction may be towards an outer section of an aerosol generating material transfer component.

In one aspect, the heating sections comprise a first series of heating sections and a second series of heating sections. In one aspect, the first series of heating sections are obliquely angled with respect to the axis defined by the aerosol generating component towards a first direction. In one aspect, the first series of heating sections are arranged to divert airflow in the first direction in use. In one aspect, the second series of heating sections are obliquely angled with respect to the axis defined by the aerosol generating component towards a second direction. In one aspect, the second series of heating sections are arranged to divert airflow in the second direction in use. In one aspect, the first direction is different from the second direction. In one aspect, the first direction is opposite from the second direction.

In one aspect, the aerosol generating component comprises opposing ends. In one aspect, an “end” corresponds to the point of the aerosol generating component at which the longest dimension of the aerosol generating component terminates. In one aspect, an “end” corresponds to the outermost edge of an outermost heating section.

In one aspect, oblique angle may be at least 20°, such as at least 30°, such as at least 40°, such as at least 50°, such as at least 60°, such as at least 70°, or such as at least 75°. In one aspect, the oblique angle is no greater than 85°, such as no greater than 80°.

In one aspect, the oblique angle of a heating section closer to an end of the aerosol generating component, is different from the oblique angle of a heating section further from an end of the aerosol generating component. In one aspect, the oblique angle of a heating section of the first series closer to an end of the aerosol generating component, is different from the oblique angle of a heating section of the first series further from an end of the aerosol generating component.

In one aspect, the oblique angle of a heating section of the second series closer to an end of the aerosol generating component, is different from the oblique angle of a heating section of the second series further from an end of the aerosol generating component.

In one aspect, the the oblique angle of a heating section closer to an end of the aerosol generating component, is less than the oblique angle of a heating section further from an end of the aerosol generating component. In one aspect, the oblique angle of a heating section of the first series closer to an end of the aerosol generating component, is less than the oblique angle of a heating section of the first series further from an end of the aerosol generating component. In one aspect, the oblique angle of a heating section of the second series closer to an end of the aerosol generating component, is less than the oblique angle of a heating section of the second series further from an end of the aerosol generating component.

In one aspect, the oblique angles of the heating sections progressively decrease with increasing proximity of the heating section to an end of the aerosol generating component. In one aspect, the oblique angles of the heating sections of the first series progressively decrease with increasing proximity of the heating section to an end of the aerosol generating component.

In one aspect, the oblique angles of the heating sections of the second series progressively decrease with increasing proximity of the heating section to an end of the aerosol generating component.

In one aspect, the aerosol generating component is generally planar. In one aspect, the plane of the aerosol generating component is the plane of best fit through the aerosol generating component.

In one aspect, the aerosol generating component is formed from a single layer.

In one aspect, the aerosol generating component is an electrically resistive heating element.

In one aspect, the aerosol generating component is an induction heating element.

In one aspect, the aerosol generating component is formed of a metallic material.

In one aspect, the aerosol generating component comprises one or more connecting sections.

In one aspect, each of the heating sections is connected to the or each connecting section. In one aspect, an edge of each of the heating sections is connected to the connecting section. In one aspect, opposing edges of each of the heating sections are connected to a respective connecting section. In one aspect, the or each connecting section is elongate. In one aspect, the or each connecting section is substantially straight. In one aspect, “connected” means “integrally connected” or “integrally formed”. In one aspect, the or each connecting section extends in the direction of the axis defined by the aerosol generating component. In one aspect, the or each connecting section aligns with the axis defined by the aerosol generating component. In one aspect, the or each connecting section is substantially parallel with the axis defined by the aerosol generating component.

According to a second aspect of the present disclosure, there is provided an article for use as part of an aerosol provision system, the article comprising: a housing comprising an airflow channel; and an aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component, wherein the aerosol generating component is arranged in the airflow channel.

In one aspect, at least a portion of the airflow channel is substantially perpendicular to the plane of the aerosol generating component.

In one aspect, the article comprises an aerosol generating material transfer component.

In one aspect, the aerosol generating material transfer component is porous. In one aspect, the aerosol generating material transfer component is a wick.

In one aspect, the aerosol generating material transfer component is arranged adjacent to (e.g. and spaced apart from) the aerosol generating component. In one aspect, the aerosol generating material transfer component is arranged in contact with the aerosol generating component. In one aspect, the aerosol generating component is arranged such that in use the aerosol generating component can volatilise aerosolisable material in the aerosol generating material transfer component.

In one aspect, the article comprises an aerosol generation chamber.

In one aspect, the aerosol generating component is arranged in the aerosol generation chamber.

In one aspect, the airflow channel extends through the aerosol generation chamber.

The aerosol generating component may be characterised in accordance with any features of the first aspect of the present disclosure.

According to a third aspect of the present disclosure, there is provided an aerosol provision system comprising: an article comprising: a housing comprising an airflow channel; and an aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component; wherein the aerosol generating component is arranged in the airflow channel; and a device for connecting to the article and delivering power to the aerosol generating component, the device comprising one or more of a power source and a controller.

In one aspect, the aerosol provision system is a non-combustible aerosol provision system.

The article may be characterised in accordance with any features of the second aspect of the present disclosure.

The article may be characterised in accordance with any of the features of the second aspect of the present disclosure.

According to a fourth aspect of the present disclosure, there is provided a method of manufacturing an aerosol generating component for use as part of an aerosol provision system, the aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component, the method comprising: providing cuts in a substantially planar sheet to define a plurality of blanks; and twisting the blanks to provide the plurality of generally planar heating sections.

The aerosol generating component may be characterised in accordance with any features of the first aspect of the present disclosure.

The article may be characterised in accordance with any of the features of the second aspect of the present disclosure.

The system may be characterised in accordance with any of the features of the third aspect of the present disclosure.

### BRIEF DESCRIPTION OF THE DRAWINGS

Various embodiments will now be described in detail by way of example only with reference to the accompanying drawings in which:

FIG. 1 is a schematic representation of an aerosol provision system according to the present disclosure:

FIG. 2 is a side view of an aerosol generating component and an aerosol generating material transfer component of an article according to the present disclosure;

FIG. 3 is a perspective view of the aerosol generating component of FIG. 2;

FIG. 4 is a side view of an aerosol generating component and an aerosol generating material transfer component according to the present disclosure;

FIG. 5 is a perspective view of the aerosol generating component of FIG. 4;

FIG. 6 is a side view of an aerosol generating component according to the present disclosure;

FIG. 7 is a side view of an aerosol generating component and an aerosol generating material transfer component according to the present disclosure;

FIG. 8 is a side view of an aerosol generating component and an aerosol generating material transfer component according to the present disclosure;

FIG. 9 is a side view of an aerosol generating component and an aerosol generating material transfer component according to the present disclosure; and

FIG. 10 is a plan view of the aerosol generating component of FIG. 9.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

As described above, the present disclosure relates, but is not limited, to non-combustible aerosol provision systems and articles that generate an aerosol from an aerosol-generating material (also referred to herein as “aerosolisable material”) without combusting the aerosol-generating material. Examples of such systems include electronic cigarettes, tobacco heating systems, and hybrid systems (which generate aerosol using a combination of aerosol-generating materials). In some examples, the non-combustible aerosol provision system is an electronic cigarette, also known as a vaping device or electronic nicotine delivery system (END), although it is noted that the presence of nicotine in the aerosol-generating material is not a requirement of the present disclosure. In some examples, the non-combustible aerosol provision system is an aerosol-generating material heating system, also known as a heat-not-burn system. An example of such a system is a tobacco heating system. In some examples, the non-combustible aerosol provision system is a hybrid system to generate aerosol using a combination of aerosol-generating materials, one or a plurality of which may be heated. Each of the aerosol-generating materials in such a hybrid system may be, for example, in the form of a solid, liquid or gel and may or may not contain nicotine. In some examples, the hybrid system comprises a liquid or gel aerosol-generating material and a solid aerosol-generating material. The solid aerosol-generating material may comprise, for example, tobacco or a non-tobacco product.

Throughout the following description the terms “e-cigarette” and “electronic cigarette” may sometimes be used. However, it will be appreciated these terms may be used interchangeably with non-combustible aerosol (vapour) provision system or device as explained above.

In some examples, the present disclosure relates to consumables for holding aerosol-generating material, and which are configured to be used with non-combustible aerosol provision devices. These consumables may be referred to as “articles” throughout the present disclosure.

The non-combustible aerosol provision system typically comprises a device part (also referred to herein as a “device”) and a consumable/article part (also referred to herein as an “article”). The device part typically comprises one or more of a power source and a controller. The power source may typically be an electrical power source, e.g. a rechargeable battery.

In some examples, the non-combustible aerosol provision system may comprise an area for receiving or engaging with the consumable/article, an aerosol generator (which may or may not be within the consumable/article), an aerosol generation area (which may be within the consumable/article), a housing, a mouthpiece, a filter and/or an aerosol-modifying agent.

In some examples, the consumable/article for use with the non-combustible aerosol provision system may comprise aerosol-generating material, an aerosol-generating material storage area (also referred to herein as a reservoir for aerosolisable material), an aerosol-generating material transfer component (e.g. a wick, such as a pad), an aerosol generator (also referred to herein as an aerosol generating component), an aerosol generation area (also referred to herein as an aerosol generation chamber), a housing, a wrapper, a filter, a mouthpiece, and/or an aerosol-modifying agent.

The systems described herein typically generate an inhalable aerosol by vaporisation of an aerosol generating material. The aerosol generating material may comprise one or more active constituents, one or more flavours, one or more aerosol-former materials, and/or one or more other functional materials.

Aerosol-generating material may, for example, be in the form of a solid, liquid or gel which may or may not contain an active substance and/or flavourants. In some examples, the aerosol-generating material may comprise an “amorphous solid”, which may alternatively be referred to as a “monolithic solid” (i.e. non-fibrous). In some examples, the amorphous solid may be a dried gel. The amorphous solid is a solid material that may retain some fluid, such as liquid, within it. In some examples, the aerosol-generating material may for example comprise from about 50 wt %, 60 wt % or 70 wt % of amorphous solid, to about 90 wt %, 95 wt % or 100 wt % of amorphous solid.

The term “active substance” as used herein may relate to a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, Cannabis or another botanical.

The aerosol-former material may comprise one or more constituents capable of forming an aerosol. In some examples, the aerosol-former material may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional materials may comprise one or more of pH regulators, colouring agents, preservatives, binders, fillers, stabilizers, and/or antioxidants.

As used herein, the term “component” is used to refer to a part, section, unit, module, assembly or similar of an electronic cigarette or similar device that incorporates several smaller parts or elements, possibly within an exterior housing or wall. An electronic cigarette may be formed or built from one or more such components, and the components may be removably or separably connectable to one another, or may be permanently joined together during manufacture to define the whole electronic cigarette. The present disclosure is applicable to (but not limited to) systems comprising two components separably connectable to one another and configured, for example, as a consumable/article component capable of holding an aerosol generating material (also referred to herein as a cartridge or cartomiser), and a device/control unit having a battery for providing electrical power to operate an element for generating vapour from the aerosol generating material.

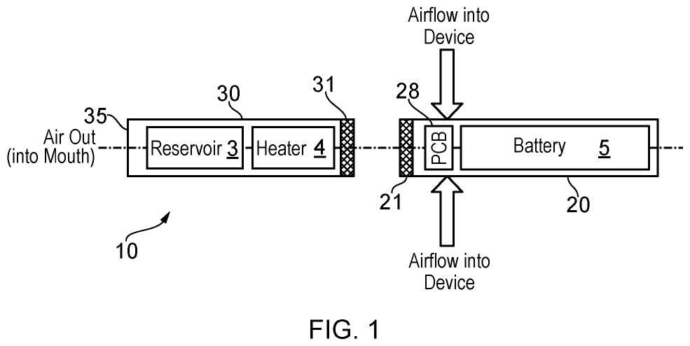

FIG. 1 is a highly schematic diagram (not to scale) of an example non-combustible aerosol provision system such as an e-cigarette 10. The e-cigarette 10 has a generally cylindrical shape, extending along a longitudinal axis indicated by a dashed line, and comprises two main components, namely a control or power component or section 20 (which may be referred to herein as a device) and a cartridge assembly or section 30 (which may be referred to herein as an “article”, “consumable”, “cartomizer”, or “cartridge”) that operates as a vapour generating component.

The cartridge assembly 30 includes a storage compartment (also referred to herein as a reservoir) 3 containing an aerosolisable material comprising (for example) a liquid formulation from which an aerosol is to be generated, for example containing nicotine. As an example, the aerosolisable material may comprise around 1 to 3% nicotine and 50% glycerol, with the remainder comprising roughly propylene glycol, and possibly also comprising other components, such as water or flavourings. The storage compartment 3 has the form of a storage tank, being a container or receptacle in which aerosolisable material can be stored such that the aerosolisable material is free to move and flow (if liquid) within the confines of the tank. Alternatively, the storage compartment 3 may contain a quantity of absorbent material such as cotton wadding or glass fibre which holds the aerosolisable material within a porous structure. The storage compartment 3 may be sealed after filling during manufacture so as to be disposable after the aerosolisable material is consumed, or may have an inlet port or other opening through which new aerosolisable material can be added. The cartridge assembly 30 also comprises an electrical aerosol generating component 4 located externally of the reservoir tank 3 for generating the aerosol by vaporisation of the aerosolisable material. In many examples, the aerosol generating component may be a heating element (heater) which is heated by the passage of electrical current (via resistive or inductive heating) to raise the temperature of the aerosolisable material until it evaporates. An aerosol generating material transfer component such as a wick or other porous element (not shown) may be provided to deliver aerosolisable material from the storage compartment 3 to the aerosol generating component 4. The wick may have one or more parts located inside the storage compartment 3 so as to be able to absorb aerosolisable material and transfer it by wicking or capillary action to other parts of the wick that are in contact with the aerosol generating component 4. This aerosolisable material is thereby vaporised, and is to be replaced by new aerosolisable material transferred to the aerosol generating component 4 by the wick.

A heater and wick combination, or other arrangement of parts that perform the same functions, is sometimes referred to as an atomiser or atomiser assembly. Various designs are possible, in which the parts may be differently arranged compared to the highly schematic representation of FIG. 1. For example, the wick may be an entirely separate element from the aerosol generating component, or the aerosol generating component may be configured to be porous and able to perform the wicking function directly (by taking the form of a suitable electrically resistive mesh or capillary body, for example).

In some cases, the aerosol generating material transfer component for delivering liquid for vapour generation may be formed at least in part from one or more slots, tubes or channels between the storage compartment and the aerosol generating component which are narrow enough to support capillary action to draw source liquid out of the storage compartment and deliver it for vaporisation. In general, an atomiser can be considered to be an aerosol generating component able to generate vapour from aerosolisable material delivered to it, and a liquid conduit (pathway) able to deliver or transport liquid from a storage compartment or similar liquid store to the aerosol generating component by a capillary force.

Typically, the aerosol generating component is at least partly located within an aerosol generating chamber that forms part of an airflow channel through the electronic cigarette/system. Vapour produced by the aerosol generating component is driven off into this chamber, and as air passes through the chamber, flowing over and around the aerosol generating component, it collects the produced vapour whereby it condenses to form the required aerosol.

Returning to FIG. 1, the cartridge assembly 30 also includes a mouthpiece 35 having an opening or air outlet through which a user may inhale the aerosol generated by the aerosol generating component 4, and delivered through the airflow channel.

The power component 20 (or power source) includes a cell 5 (also referred to herein as a battery, and which may be re-chargeable) to provide power for electrical components of the e-cigarette 10, in particular the aerosol generating component 4. Additionally, there is a printed circuit board 28 and/or other electronics or circuitry for generally controlling the e-cigarette. The control electronics/circuitry connect the vapour generating element 4 to the battery 5 when vapour is required, for example in response to a signal from an air pressure sensor or air flow sensor (not shown) that detects an inhalation on the system 10 during which air enters through one or more air inlets 26 in the wall of the power component 20 to flow along the airflow channel. When the aerosol generating component 4 receives power from the battery 5, the aerosol generating component 4 vaporises aerosolisable material delivered from the storage compartment 3 to generate the aerosol, and this is then inhaled by a user through the opening in the mouthpiece 35. The aerosol is carried to the mouthpiece 35 along the airflow channel (not shown) that connects the air inlet 26 to the air outlet when a user inhales on the mouthpiece 35. An airflow path through the electronic cigarette is hence defined, between the air inlet(s) (which may or may not be in the power component) to the atomiser and on to the air outlet at the mouthpiece. In use, the air flow direction along this airflow path is from the air inlet to the air outlet, so that the atomiser can be described as lying downstream of the air inlet and upstream of the air outlet.

In this particular example, the power section 20 and the cartridge assembly 30 are separate parts detachable from one another by separation in a direction parallel to the longitudinal axis, as indicated by the solid arrows in FIG. 1. The components 20, 30 are joined together when the device 10 is in use by cooperating engagement elements 21, 31 (for example, a screw, magnetic or bayonet fitting) which provide mechanical and electrical connectivity between the power section 20 and the cartridge assembly 30. This is merely an example arrangement, however, and the various components may be differently distributed between the power section 20 and the cartridge assembly section 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections may be intended to be disposed of and replaced when exhausted (the reservoir is empty or the battery is flat, for example), or be intended for multiple uses enabled by actions such as refilling the reservoir, recharging the battery, or replacing the atomiser. Alternatively, the e-cigarette 10 may be a unitary device (disposable or refillable/rechargeable) that cannot be separated into two or more parts, in which case all components are comprised within a single body or housing. Examples of the present invention are applicable to any of these configurations and other configurations of which the skilled person will be aware.

As mentioned, a type of aerosol generating component, such as a heating element, that may be utilised in an atomising portion of an electronic cigarette (a part configured to generate vapour from a source liquid) combines the functions of heating and liquid delivery, by being both electrically conductive (resistive) and porous. Note here that reference to being electrically conductive (resistive) refers to components which have the capacity to generate heat in response to the flow of electrical current therein. Such flow could be imparted by via so-called resistive heating or induction heating. An example of a suitable material for this is an electrically conductive material such as a metal or metal alloy formed into a sheet-like form, i.e. a planar shape with a thickness many times smaller than its length or breadth. Examples in this regard may be a mesh, web, grill and the like. The mesh may be formed from metal wires or fibres which are woven together, or alternatively aggregated into a non-woven structure. For example, fibres may be aggregated by sintering, in which heat and/or pressure are applied to a collection of metal fibres to compact them into a single porous mass. It is possible for the planar aerosol generating component to define a curved plane and in these instances reference to the planar aerosol generating component forming a plane means an imaginary flat plane forming a plane of best fit through the component.

These structures can give appropriately sized voids and interstices between the metal fibres to provide a capillary force for wicking liquid. Thus, these structures can also be considered to be porous since they provide for the uptake and distribution of liquid. Moreover, due to the presence of voids and interstices between the metal fibres, it is possible for air to permeate through said structures. Also, the metal is electrically conductive and therefore suitable for resistive heating, whereby electrical current flowing through a material with electrical resistance generates heat. Structures of this type are not limited to metals, however. Other conductive materials may be formed into fibres and made into mesh, grill or web structures. Examples include ceramic materials, which may or may not be doped with substances intended to tailor the physical properties of the mesh.

A planar sheet-like porous aerosol generating component of this kind can be arranged within an electronic cigarette such that it lies within the aerosol generating chamber forming part of an airflow channel. The aerosol generating component may be oriented within the chamber such that air flow though the chamber may flow in a surface direction, i.e. substantially parallel to the plane of the generally planar sheet-like aerosol generating component. An example of such a configuration can be found in WO2010/045670 and WO2010/045671, the contents of which are incorporated herein in their entirety by reference. Air can thence flow over the heating element, and gather vapour. Aerosol generation is thereby made very effective. In alternative examples, the aerosol generating component may be oriented within the chamber such that air flow though the chamber may flow in a direction which is substantially transverse to the surface direction, i.e. substantially orthogonally to the plane of the generally planar sheet-like aerosol generating component. An example of such a configuration can be found in WO2018/211252, the contents of which are incorporated herein in its entirety by reference.

The aerosol generating component may have, and/or be formed of, any one of the following structures: a woven or weave structure, mesh structure, fabric structure, open-pored fiber structure, open-pored sintered structure, open-pored foam or open-pored deposition structure. Said structures are suitable in particular for providing an aerosol generating component with a high degree of porosity. A high degree of porosity may ensure that the heat produced by the aerosol generating component is predominately used for evaporating the liquid and high efficiency can be obtained. A porosity of greater than 50% may be envisaged with said structures. In one embodiment, the porosity of the aerosol generating component is 50% or greater, 60% or greater, 70% or greater. The open-pored fiber structure can consist, for example, of a non-woven fabric which can be arbitrarily compacted, and can additionally be sintered in order to improve the cohesion. The open-pored sintered structure can consist, for example, of a granular, fibrous or flocculent sintered composite produced by a film casting process. The open-pored deposition structure can be produced, for example, by a CVD process, PVD process or by flame spraying. Open-pored foams are in principle commercially available and are also obtainable in a thin, fine-pored design.

In one embodiment, the aerosol generating component is formed from a single layer. In one embodiment, the aerosol generating component has at least two layers, wherein the layers contain at least one of the following structures: a plate, foil, paper, mesh, woven structure, fabric, open-pored fiber structure, open-pored sintered structure, open-pored foam or open-pored deposition structure. For example, the aerosol generating component can be formed by an electric heating resistor consisting of a metal foil combined with a structure comprising a capillary structure. Where the aerosol generating component is considered to be formed from a single layer, such a layer may be formed from a metal wire fabric, or from a non-woven metal fiber fabric. Individual layers are advantageously but not necessarily connected to one another by a heat treatment, such as sintering or welding. For example, the aerosol generating component can be designed as a sintered composite consisting of a stainless steel foil and one or more layers of a stainless steel wire fabric (material, for example AISI 304 or AISI 316). Alternatively, the aerosol generating component can be designed as a sintered composite consisting of at least two layers of a stainless steel wire fabric. The layers may be connected to one another by spot welding or resistance welding. Individual layers may also be connected to one another mechanically. For instance, a double-layer wire fabric could be produced just by folding a single layer. Instead of stainless steel, use may also be made, by way of example, of heating conductor alloys-in particular NiCr alloys and CrFeAl alloys (“Kanthal”) which have an even higher specific electric resistance than stainless steel. The material connection between the layers is obtained by the heat treatment, as a result of which the layers maintain contact with one another-even under adverse conditions, for example during heating by the aerosol generating component and resultantly induced thermal expansions. Alternatively, the aerosol generating component may be formed from sintering a plurality of individual fibers together. Thus, the aerosol generating component can be comprised of sintered fibers, such as sintered metal fibers.

The aerosol generating component may comprise, for example, an electrically conductive thin layer of electrically resistive material, such as platinum, nickel, molybdenum, tungsten or tantalum, said thin layer being applied to a surface of the vaporizer by a PVD or CVD process, or any other suitable process. In this case, the aerosol generating component may comprise an electrically insulating material, for example of ceramic. Examples of suitable electrically resistive material include stainless steels, such as AISI 304 or AISI 316, and heating conductor alloys-in particular NiCr alloys and CrFeAl alloys (“Kanthal”), such as DIN material number 2,4658, 2,4867, 2,4869, 2,4872, 1,4843, 1,4860, 1,4725, 1,4765 and 1,4767.

As described above, the aerosol generating component may be formed from a sintered metal fiber material and may be in the form of a sheet. Material of this sort can be thought of a mesh or irregular grid, and is created by sintering together a randomly aligned arrangement or array of spaced apart metal fibers or strands. A single layer of fibers might be used, or several layers, for example up to five layers. As an example, the metal fibers may have a diameter of 8 to 12 μm, arranged to give a sheet of thickness 0.16 mm, and spaced to produce a material density of from 100 g/m² to 1500 g/m², such as from 150 g/m² to 1000 g/m², 200 g/m² to 500 g/m², or 200 to 250 g/m², and a porosity of 84%. The sheet thickness may also range from 0.1 mm to 0.2 mm, such as 0.1 mm to 0.15 mm. Specific thicknesses include 0.10 mm, 0.11 mm, 0.12 mm, 0.13 mm, 0.14 mm, 0.15 mm or 0.1 mm. Generally, the aerosol generating component has a uniform thickness. However, it will be appreciated from the discussion below that the thickness of the aerosol generating component may also vary. This may be due, for example, to some parts of the aerosol generating component having undergone compression. Different fiber diameters and thicknesses may be selected to vary the porosity of the aerosol generating component. For example, the aerosol generating component may have a porosity of 66% or greater, or 70% or greater, or 75% or greater, or 80% or greater or 85% or greater, or 86% or greater.

The aerosol generating component may form a generally flat structure, comprising first and second surfaces. The generally flat structure may take the form of any two dimensional shape, for example, circular, semi-circular, triangular, square, rectangular and/or polygonal. Generally, the aerosol generating component has a uniform thickness.

A width and/or length of the aerosol generating component may be from about 1 mm to about 50 mm. For example, the width and/or length of the vaporizer may be from 1 mm, 2 mm, 3 mm, 4 mm, 5 mm, 6 mm, 7 mm, 8 mm, 9 mm or 10 mm. The width may generally be smaller than the length of the aerosol generating component. It will be understood that the dimensions of the aerosol generating component may be varied.

Where the aerosol generating component is formed from an electrically resistive material, electrical current is permitted to flow through the aerosol generating component so as to generate heat (so called Joule heating). In this regard, the electrical resistance of the aerosol generating component can be selected appropriately. For example, the aerosol generating component may have an electrical resistance of 2 ohms or less, such as 1.8 ohms or less, such as 1.7 ohms or less, such as 1.6 ohms or less, such as 1.5 ohms or less, such as 1.4 ohms or less, such as 1.3 ohms or less, such as 1.2 ohms or less, such as 1.1 ohms or less, such as 1.0 ohm or less, such as 0.9 ohms or less, such as 0.8 ohms or less, such as 0.7 ohms or less, such as 0.6 ohms or less, such as 0.5 ohms or less. The parameters of the aerosol generating component, such as material, thickness, width, length, porosity etc. can be selected so as to provide the desired resistance. In this regard, a relatively lower resistance will facilitate higher power draw from the power source, which can be advantageous in producing a high rate of aerosolisation. On the other hand, the resistance should not be so low so as to prejudice the integrity of the aerosol generator. For example, the resistance may not be lower than 0.5 ohms. The aerosol generating component may have a first electrical connector and a second electrical connector. The first electrical connector and the second electrical connector may be arranged at opposing ends of the aerosol generating component from each other. The electrical resistance may be between the first electrical connector and the second electrical connector. Each of the electrical connectors may be for connection to an electrical contact such that the aerosol generating component can be energised.

Planar aerosol generating components, such as heating elements, suitable for use in systems, devices and articles disclosed herein may be formed by stamping or cutting (such as laser cutting) the required shape from a larger sheet of porous material. This may include stamping out, cutting away or otherwise removing material to create openings in the aerosol generating component. These openings can influence both the ability for air to pass through the aerosol generating component and the propensity for electrical current to flow in certain areas.

In an aspect of the present disclosure, there is provided an aerosol generating component 100 for use as part of a non-combustible aerosol provision system 10, the aerosol generating component 100 defining an axis X and comprising a plurality of generally planar heating sections 101, wherein the generally planar heating sections 101 are arranged along the axis X defined by the aerosol generating component 100 and spaced apart from each other, wherein the plane of each heating section 101 is obliquely angled with respect to the axis X defined by the aerosol generating component 100.

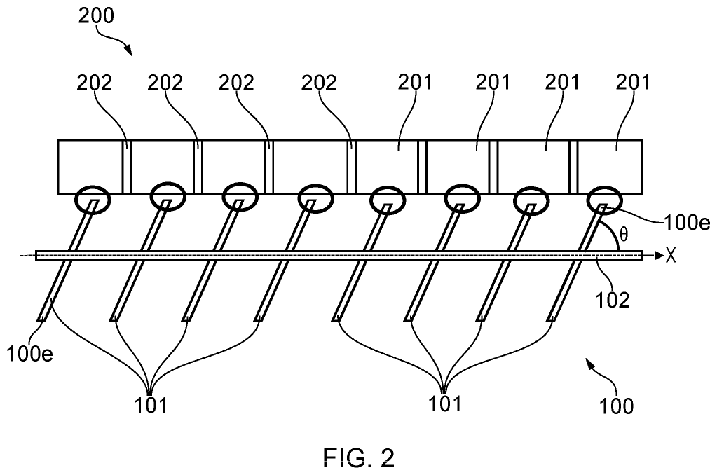

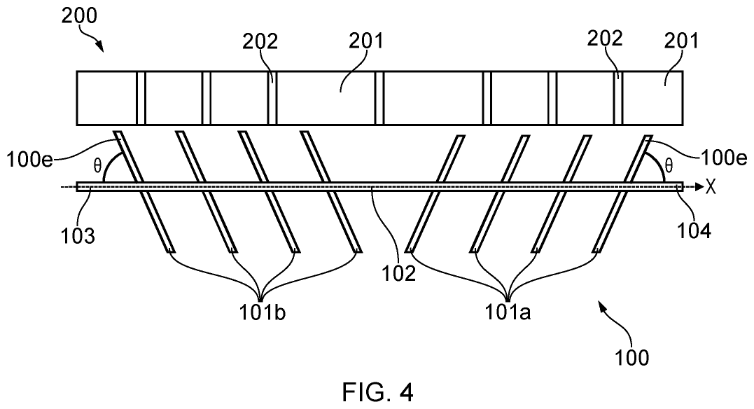

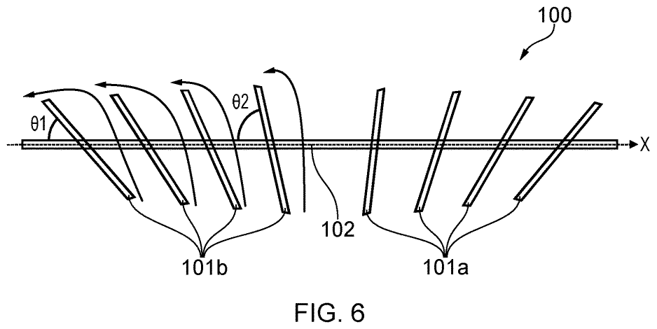

Example aerosol generating components 100 are shown in FIGS. 2 to 8. In FIGS. 4, 5, 7, and 8, the aerosol generating components 100 are the same. The aerosol generating component 100 of FIG. 6 is the same as those of FIGS. 4, 5, 7, and 8, except that in FIG. 6 the oblique angle is varied, as discussed herein.

The present inventors have discovered that by virtue of the obliquely angled heating sections 101, the aerosol generating component 100 can be configured to effectively control the direction of airflow in use. For example, the aerosol generating component 100 may be configured so as to divert airflow to a particular location or component (e.g. an aerosol generating material transfer component or specific regions thereof) in use. By effectively controlling the airflow in use, improvements in aerosol generation and/or aerosol properties have been observed.

Herein, “obliquely angled” means at an angle of greater than 0° and less than 90°. The oblique angle (as indicated in the figures by θ) may be at least 20°. The oblique angle may be at least 30°. The oblique angle may be at least 40°. The oblique angle may be at least 50°. The oblique angle may be at least 60°. The oblique angle may be at least 70°. The oblique angle may be at least 75°. The oblique angle may be no greater than 85°. The oblique angle may be no greater than 80°.

The axis X defined by the aerosol generating component 100 may be selected from: the longitudinal axis X of the aerosol generating component 100, the transverse axis of the aerosol generating component, and the axis X of the aerosol generating component 100 along which air flows in use. In the embodiments of FIGS. 2 to 6, the axis X corresponds to the longitudinal axis of the aerosol generating component 100 and the axis of the aerosol generating component 100 along which air flows in use. Those skilled in the art will appreciate that the definition of the axis X may be varied.

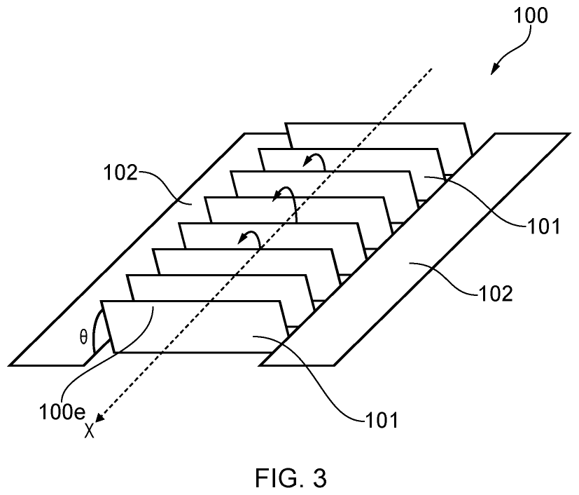

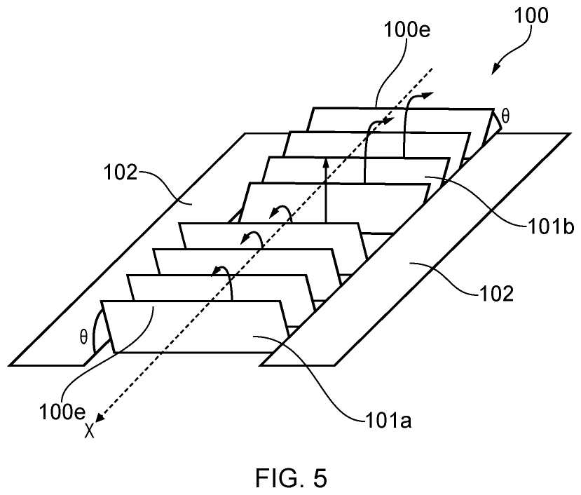

The aerosol generating component 100 may comprise opposing ends 100e, as shown in FIGS. 2 to 8. In this context, an “end” may correspond to the point of the aerosol generating component 100 at which the longest dimension of the aerosol generating component 100 terminates (see e.g. FIGS. 3 and 5). In this context, an “end” may correspond to the outermost edge of an outermost heating section 101 (see e.g. FIGS. 3 and 5). For example, as shown in FIGS. 3 and 5, airflow can flow from a relatively central region of the aerosol generating component 100 to and over an end 100e of the aerosol generating component in use.

The heating sections 101 may be arranged to divert airflow in a direction in use. The direction may be towards a particular location or component in use. For example, the direction may be towards an aerosol generating material transfer component 200 (or specific regions thereof).

The heating sections 101 may be obliquely angled with respect to the axis X towards a particular direction. The heating sections may be obliquely angled with respect to the axis X towards an end 100e of the aerosol generating component 100.

For example, in the aerosol generating component 100 shown in FIGS. 2 and 3, the heating sections 101 comprise a series of heating sections 101. The heating sections 101 may be arranged sequentially and consecutively along the axis X. The series of heating sections 101 may be obliquely angled with respect to the axis X in a common direction. In particular, the series of heating sections 101 may be obliquely angled with respect to the axis X towards an end 100e (the same end) of the aerosol generating component. Thus, in the embodiment of FIGS. 2 and 3, the heating sections 101 can be considered to form a “louvred” arrangement. In use, in the aerosol generating component 100 shown in FIGS. 2 and 3, the series of heating sections 101 may be arranged to divert airflow towards an end 100e (the same end) of the aerosol generating component 100 (i.e. towards the letter “X” in FIG. 2). The directionality of the airflow is illustrated by the curved arrows in FIG. 3. In the aerosol generating component 100 shown in FIGS. 2 and 3, each of the oblique angles is the same. It will be appreciated, however, that the oblique angle may be varied.

For example, in FIGS. 4 to 8, the heating sections 101 comprise a first series 101a of heating sections 101 and a second series 101b of heating sections 101. The heating sections 101 may be arranged sequentially and consecutively along the axis X. The first series of heating sections 101a may be obliquely angled with respect to the axis X in a common direction. The second series of heating sections 101b may be obliquely angled with respect to the axis X in a common direction, which may be opposite to the direction in which the first series of heating sections 101a are obliquely angled. In particular, the first series 101a of heating sections 101 may be obliquely angled with respect to the axis X towards an end 100e of the aerosol generating component 100, and the second series 101b of heating sections 101 may be obliquely angled with respect to the axis X towards the opposite end 100e of the aerosol generating component 100. Thus, in FIGS. 4 to 8, the heating sections 101 can be considered to form a “chevron” arrangement. In use, in FIGS. 4 to 8, the first series 101a of heating sections 101 may be arranged to divert airflow towards an end 100e of the aerosol generating component 100 (towards the letter “X”). In use, in FIGS. 4 to 8, the second series 101a of heating sections 101 may be arranged to divert airflow towards an opposite end 100e of the aerosol generating component 100 (away from the letter “X”). In FIGS. 4, 5, 7, and 8, each of the oblique angles is the same. It will be appreciated, however, that the oblique angle may be varied.

As shown in FIGS. 3 and 5, the aerosol generating component 100 may further comprise one or more connecting sections 102. For example, the aerosol generating component 100 may comprises two connecting section 102. Opposing edges of each heating section 101 may be connected to a respective connecting section 102. The connecting sections 102 may be elongate, and may be substantially straight. In this context, “connected” may mean “integrally connected” or “integrally formed”. The or each connecting section 102 may extend in the direction of the axis X defined by the aerosol generating component 100. For example, the or each connecting section 102 may align with the axis X defined by the aerosol generating component 100. For example, the or each connecting section 102 may be substantially parallel with the axis X defined by the aerosol generating component 100. Advantageously, the connecting section(s) 102 provide support to the heating sections.

Each of the generally planar heating sections 101 may define an axis Y (see FIGS. 3 and 5). The axis Y may be the longitudinal axis Y of the heating section 101 (as shown in FIGS. 3 and 5), or the transverse axis of the heating section 101. The axis Y may be substantially perpendicular to the axis X of the aerosol generating component 100. Those skilled in the art will appreciate that the definition of the axis Y may be varied.

The aerosol generating component 100 of FIG. 6 is the same as those of FIGS. 4, 5, 7, and 8, except that in FIG. 6 the oblique angles are varied. For example, in FIG. 6, the oblique angle of a heating section 101 closer to an end 100e of the aerosol generating component 100 (see e.g. θ1), is different from the oblique angle of a heating section 101 further from an end 100e of the aerosol generating component 100 (see e.g. θ2). For example, the oblique angle of a heating section 101 of the first series 101a closer to an end 100e of the aerosol generating component 100, is different from the oblique angle of a heating section 101 of the first series 101a further from an end 100e of the aerosol generating component 100; and the oblique angle of a heating section 101 of the second series 101b closer to an end 100e of the aerosol generating component 100, is different from the oblique angle of a heating section 101 of the second series 101b further from an end 100e of the aerosol generating component 100. In particular, in FIG. 6, the oblique angle of a heating section 101 closer to an end 100e of the aerosol generating component 100, is less than the oblique angle of a heating section 101 further from an end 100e of the aerosol generating component 100. More specifically, the oblique angle of a heating section 101 of the first series 101a closer to an end 100e of the aerosol generating component 100, is less than the oblique angle of a heating section 101 of the first series 101a further from an end 100e of the aerosol generating component 100; and the oblique angle of a heating section 101 of the second series 101b closer to an end 100e of the aerosol generating component 100, is less than the oblique angle of a heating section 101 of the second series 101b further from an end 100e of the aerosol generating component 100.

In some aspects, the oblique angles of the heating sections progressively decrease with increasing proximity of the heating section 101 to an end 101e of the aerosol generating component 100 (e.g. see θ1 in comparison with 62 in FIG. 6). In some aspects, the oblique angles of the heating sections 101 of the first series 101a progressively decrease with increasing proximity of the heating section 101 to an end 100e of the aerosol generating component 100. In some aspects, the oblique angles of the heating sections 101 of the second series 101b progressively decrease with increasing proximity of the heating section 101 to an end 100e of the aerosol generating component 100.

Advantageously, the use of a varying oblique angle can help to preferentially drive airflow towards outer sections of the aerosol generating component 100, for example towards outer sections of an aerosol generating material transfer component 200. This may promote aerosol generation, particularly at such outer sections of the aerosol generating material transfer component 200. In turn, this may result in improved and/or more consistent aerosol generation.

The aerosol generating component 100 may comprise or be formed from one or more of: a woven or weave structure, mesh structure, fabric structure, open-pored fiber structure, open-pored sintered structure, open-pored foam, and open-pored deposition structure.

The aerosol generating component 100 may comprise or be formed of an electrically conductive material. For example, the aerosol generating component 100 may comprise or be formed from an electrically resistive material. For example, the aerosol generating component 100 may comprise or be formed from a metallic material. For example, the aerosol generating component 100 may comprise or be formed from a metal. For example, the aerosol generating component 100 may comprise or be formed from a metal alloy. For example, the aerosol generating component 100 may comprise or be formed from stainless steel (such as stainless steel 316). The aerosol generating component 100 may be an electrically resistive heating element. The aerosol generating component 100 may be an induction heating element.

According to an aspect of the present disclosure, there is provided an article 30 for use as part of an aerosol provision system 10, the article 30 comprising: a housing comprising an airflow channel; and an aerosol generating component 100 defining an axis X and comprising a plurality of generally planar heating sections 101, wherein the generally planar heating sections 101 are arranged along the axis X defined by the aerosol generating component 100 and spaced apart from each other, wherein the plane of each heating section 101 is obliquely angled with respect to the axis X defined by the aerosol generating component 100, wherein the aerosol generating component 100 is arranged in the airflow channel.

At least a portion of the airflow channel may be non-parallel (e.g. substantially perpendicular) to the plane of the aerosol generating component 100. Herein, the plane of the generally planar aerosol generating component 100 may be considered as the plane of best fit through the aerosol generating component 100. This allows for a degree of curvature to be present in the aerosol generating component 100.

The aerosol generating component 100 may be arranged in an aerosol generation chamber. The airflow channel may extend through the aerosol generation chamber.

The article 30 may comprise an aerosol generating material transfer component 200 (as shown in FIGS. 2 and 4). The aerosol generating material transfer component 200 may be as defined herein. The aerosol generating material transfer component 200 may be arranged adjacent to (e.g. and spaced apart from) the aerosol generating component 100. The aerosol generating material transfer component 200 may be directly contactable or arranged in direct contact with the aerosol generating component 100. For example, the aerosol generating material transfer component 200 may be arranged such that in use the aerosol generating component can volatilise aerosolisable material in the aerosol generating material transfer component 200. The aerosol generating material transfer component 200 may be supported by the aerosol generating component 100 or other means.

The aerosol generating material transfer component 200 may be porous. For example, the aerosol generating material transfer component 200 may be a wick.

In use, airflow entering the airflow channel may be diverted by the heating sections 101 in one or more directions. For example, airflow may be diverted by the heating sections 101 towards an end 100e of the aerosol generating component and/or towards an outer section of the aerosol generating material transfer component 200 (e.g. in FIGS. 2 and 3). For example, airflow may be diverted by the first series 101a of heating sections 101 towards an end 100e of the aerosol generating component 100 and/or towards an outer section of the aerosol generating material transfer component 200, and airflow may be diverted by the second series 101b of heating sections 101 towards an opposite end 100e of the aerosol generating component 100 and/or towards an opposite outer section of the aerosol generating material transfer component 200 (e.g. in FIGS. 4 to 6).

The aerosol generating component 100 may be characterised by any features of the aerosol generating component 100 of an above aspect of the present disclosure.

According to an aspect of the present disclosure, there is provided a non-combustible aerosol provision system 10 comprising: an article 30 comprising: a housing comprising an airflow channel; and an aerosol generating component 100 defining an axis and comprising a plurality of generally planar heating sections 101, wherein the heating sections 101 are arranged along the axis defined by the aerosol generating component 100 and spaced apart from each other, wherein the plane of each heating section 101 is obliquely angled with respect to the axis X defined by the aerosol generating component 100; wherein the aerosol generating component 100 is arranged in the airflow channel; and a device for connecting to and delivering electrical power to the aerosol generating component 100, the device comprising one or more of a power source and a controller.

The device may be arranged to at least partially receive the article 30. For example, the device may comprise an opening for receiving the article 30.

The article 30 may be characterised by any features of the article 30 of an above aspect of the present disclosure.

In an aspect of the present disclosure, there is provided a method of manufacturing an aerosol generating component 100 for use as part of an aerosol provision system (such as the non-combustible aerosol provision system 10), the aerosol generating component 100 defining an axis X and comprising a plurality of generally planar heating sections 101, wherein the heating sections 101 are arranged along the axis X defined by the aerosol generating component 100 and spaced apart from each other, wherein the plane of each heating section 100 is obliquely angled with respect to the axis X defined by the aerosol generating component 100, the method comprising: providing cuts in a substantially planar sheet to define a plurality of blanks; twisting the blanks to provide the plurality of generally planar heating sections 101.

The aerosol generating component 100 may be characterised by any features of the aerosol generating component 100 of an above aspect of the present disclosure.

In an aspect of the present disclosure, there is provided an aerosol generating material transfer component 200 for use as part of an aerosol provision system 10, the aerosol generating material transfer component 200 comprising: at least one electrically conductive portion 201 and at least one electrically insulating portion 202.

Example aerosol generating material transfer components are illustrated in FIGS. 2, 4, 7, 8, and 9.

The present inventors have discovered that during use of articles in which an electrically conductive portion of an aerosol generating material transfer component may, under certain conditions, directly contact respective parts of an aerosol generating component, there can be a risk of electrical short circuiting between the respective parts of the aerosol generating component via the electrically conductive portion of the aerosol generating material transfer component. The short circuiting can reduce the performance of or damage the article and/or components thereof.

By virtue of the at least one electrically insulating portion 201 of the aerosol generating material transfer component 200, there can be provided an article (e.g. 30) in which the risk of electrical short circuiting between the respective parts of the aerosol generating component 100 via the aerosol generating material transfer component 200 is reduced or prevented. Without being bound by theory, the at least one electrically insulating portion 201 is considered to increase the electrical resistance of the current path between the respective parts of the aerosol generating component 100 via the aerosol generating material transfer component 200, relative to instances wherein the aerosol generating material transfer component 200 is formed solely of an electrically conductive material (e.g. when there is direct contact between the at least one electrically conductive portion and the respective parts of the aerosol generating component). For example, the at least one electrically insulating portion 201 may be arranged to intercept the current path between the respective parts via the aerosol generating material transfer component 200. In such an arrangement, the current path cannot traverse the respective parts via the aerosol generating material transfer component 200 without being intercepted by the at least one insulating portion 201. For example, the at least one electrically insulating portion may be arranged such that the current path between the respective parts via the aerosol generating material transfer component 200 is tortuous. By increasing the electrical resistance of the current path between the respective parts via the aerosol generating material transfer component 200, the risk of electrical short circuiting between the respective parts via the aerosol generating material transfer component 200 can be reduced or prevented.

As shown in FIGS. 2, 4, 7, 8, and 9, an outer surface of the aerosol generating material transfer component 200 may comprise the at least one electrically conductive portion 201 and the at least one electrically insulating portion 202. For example, the outer surface comprising the at least one electrically conductive portion 201 and the at least one electrically insulating portion 202 may be continuous. For example, the outer surface comprising the at least one electrically conductive portion 201 and the at least one electrically insulating portion 202 may be substantially planar. For example, the outer surface comprising the at least one electrically conductive portion 201 and the at least one electrically insulating portion 202 may be substantially flat. An imaginary flat plane may form a plane of best fit through the outer surface 102 comprising the at least one electrically conductive portion 201 and the at least one electrically insulating portion 202. Advantageously, these arrangements may facilitate improved delivery of aerosolisable material from the aerosol generating material transfer component 200 and an aerosol generating component 100 in use.

The outer surface comprising the at least one electrically conductive portion 201 and the at least one electrically insulating portion 202 may be arranged adjacent to the aerosol generating material transfer component 200 of the article 30. The outer surface comprising the at least one electrically conductive portion 201 and the at least one electrically insulating portion 202 may be arranged to face the aerosol generating material transfer component 200 of the article 30.

As shown in FIGS. 2, 4, and 8, the at least one electrically conductive portion 201 may comprise electrically conductive portions 201. For example, in each of FIGS. 2, 4, and 8, the at least one electrically conductive portion 201 comprises eight electrically conductive portions 201. In some aspects, the at least one electrically insulating portion may comprise electrically insulating portions 202 (see e.g. FIG. 2).

As shown for example in FIGS. 2 and 4, the at least one electrically insulating portion 202 completely separates the electrically conductive portions 201. In this way, a current path cannot extend between the electrically conductive portions 201 without being intercepted by the at least one electrically insulating portion 202. For example, an electrically insulating portion 202 may completely separate adjacent electrically conductive portions 201. These arrangements are particularly effective at reducing or preventing short circuiting in use.

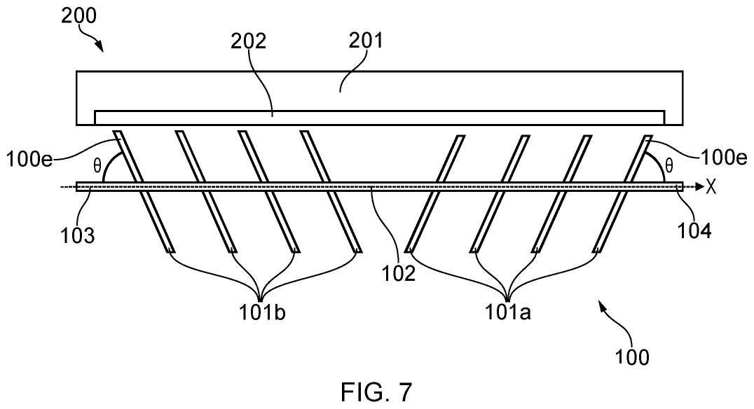

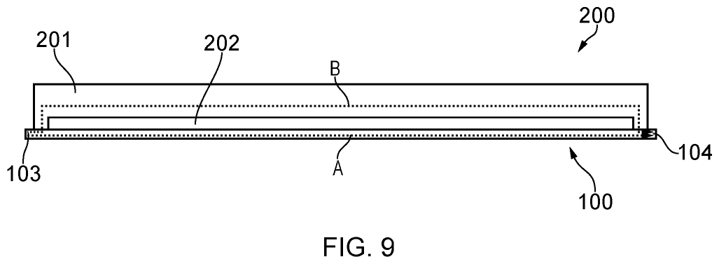

The at least one electrically conductive portion 201 and the at least one electrically insulating portion 202 may be arranged in alternating layers, e.g. as shown in FIGS. 2, 4, 7, and 9. Referring to FIGS. 2 and 4, the alternating layers may alternate in a horizontal direction. By contrast, referring to FIGS. 7 and 9, the alternating layers may alternate in a vertical direction. Both arrangements can be used to reduce or prevent short circuiting.

Referring to FIGS. 7 to 9, one of the at least one electrically conductive portion 201 and the at least one electrically insulating portion 202 may be arranged in a recess in the other of the at least one electrically conductive portion 201 and the at least one electrically insulating portion 202. That is, one of:
(A) the at least one electrically conductive portion 201; and
(B) the at least one electrically insulating portion 202,
may be arranged in a recess in the other of:
(A) the at least one electrically conductive portion 201; and
(B) the at least one electrically insulating portion 202.

For example, as shown in FIGS. 7 and 9, the at least one electrically insulating portion 202 may be arranged in a recess of the at least one electrically conductive portion 201. For example, an (e.g. a single) electrically insulating portion 202 may be arranged in a recess of an (e.g. a single) electrically conductive portion 201. Where there are electrically insulating portions 202, each electrically insulating portion 202 may be arranged in a respective recess in the at least one (e.g. a single) electrically conductive portion 201.

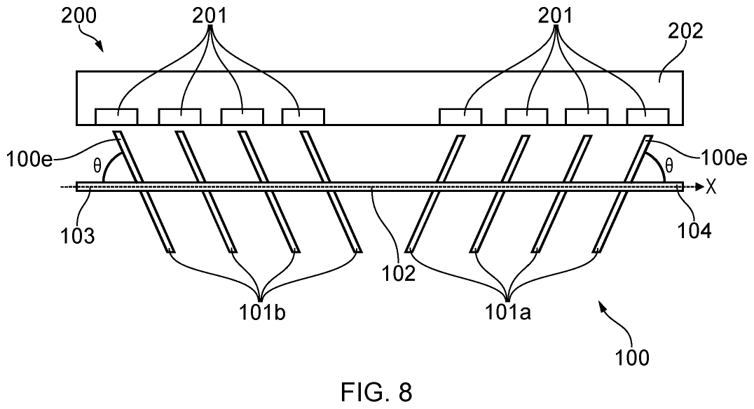

As shown in FIGS. 8 and 9, the at least one electrically conductive portion 201 may be arranged in a recess of the at least one electrically insulating portion 202. For example, where there are electrically conductive portions 201, each electrically conductive portion 201 may be arranged in a respective recess of the at least one (e.g. a single) electrically insulating portion 202. The electrically conductive portions 201 may be spaced apart from each other.

In some aspects, the aerosol generating material transfer component 200 may be porous. For example, the aerosol generating material transfer component 200 may be a wick. The aerosol generating material transfer component 200 may be suitable for transferring aerosolisable material by capillary action.

The at least one electrically conductive portion 201 may have an electrical conductivity at atmospheric pressure and 20° C. of at least 1×10⁵ S/m (Siemens per metre), at least 2×10⁵ S/m, at least 5×10⁵ S/m, at least 1×10⁶ S/m, at least 1.2×10⁶ S/m, at least 1.4×10⁶ S/m, or at least 1.4×10⁶ S/m.

The aerosol generating material transfer component 200 may be thermally conductive. In this way, the aerosol generating material transfer component 200 can effectively distribute (and/or dissipate) heat so as to avoid or reduce the risk of formation of localised “hot spots” in use. By contrast, aerosol generating material transfer components with a relatively poor thermal conductivity, such as cotton, can experience localised “hot spots”. In cotton, these localised “hot spots” can result in inadvertent formation of carbonyls.

The aerosol generating material transfer component 200 may have a thermal conductivity at atmospheric pressure and 20° C. of at least 1 W/mK (Watts per metre-Kelvin), at least 2 W/mK, at least 4 W/mK, at least 5 W/mK, at least 8 W/mK, at least 10 W/mK, at least 12 W/mK, at least 14 W/mK, or at least 15 W/mK.

The at least one electrically conductive portion 201 may comprise a metallic material. The at least one electrically conductive portion 201 may be formed of a metallic material. The metallic material may be a metal. The metallic material may be a metal alloy. The metal alloy may be stainless steel, e.g. stainless steel 316.

In FIGS. 2, 4, 7, 8, and 9, the length (left to right) and the depth (up to down) of the aerosol generating material transfer components 200 are shown. While not shown in the figures, it is to be understood that the width of the aerosol generating material transfer components 200 is substantially the same as the width of the aerosol generating component 100. Further, it is to be understood that the cross section of the aerosol generating material transfer component 200 shown in these figures is constant throughout the aerosol generating material transfer component 200. Those skilled in the art will appreciate that the form and dimensions of the aerosol generating material transfer component 200 may be varied.

According to an aspect of the present disclosure, there is provided an article 30 for use as part of a non-combustible aerosol provision system 10, the article comprising:
an aerosol generating material transfer component 200 comprising at least one electrically conductive portion 201 and at least one electrically insulating portion 202; and
an aerosol generating component 100;
wherein the aerosol generating material transfer component is arranged to deliver aerosolisable material to the aerosol generating component, and wherein the at least one electrically insulating portion 202 is arranged to reduce the risk of or prevent electrical short circuiting between respective parts of the aerosol generating component 100 via the aerosol generating material transfer component 200.

Example aerosol generating material transfer components 200 and aerosol generating components 100 together are illustrated in FIGS. 2, 4, 7, 8, and 9. The aerosol generating material transfer component 200 may be as described in accordance with any other aspect of the present disclosure. The aerosol generating component 100 may be as described in accordance with any other aspect of the present disclosure.

In some aspects, the at least one electrically conductive portion 201 is directly contactable or arranged in direct contact with respective parts of the aerosol generating component 100. The respective parts of the aerosol generating component 100 are circled in FIG. 2 (but not the other figures). As can be understood from FIGS. 2, 4, 7, and 8, the at least one conductive portion 201 may be directly contactable with the respective parts of the aerosol generating component 100. “Directly contactable” means that the at least one conductive portion 201 can, but need not necessarily, directly contact the respective parts of the aerosol generating component 100. In other words, the at least one conductive portion 201 may be spaced apart from the respective parts of the aerosol generating component 100, such that an empty space between the at least one conductive portion 201 and the respective parts of the aerosol generating component 100 is provided. In this way, direct contact between the at least one conductive portion 201 and the respective parts of the aerosol generating component 100 can occur, e.g. through general use of the article 30, which may cause relative movement of the aerosol generating material transfer component 200 and/or the aerosol generating component 100. By contrast, “direct contact” between the at least one electrically conductive portion 201 and the respective parts of the aerosol generating component 100 is illustrated in FIG. 9.

As shown in FIGS. 2, 4, 7, 8, and 9, the at least one electrically insulating portion 202 may be arranged between sections of the at least one electrically conductive portion 201 directly contactable or arranged in direct contact with the respective parts of the aerosol generating component 100.

As shown in FIGS. 2, 4, and 8, the at least one electrically conductive portion 201 may comprise electrically conductive portions 201. Each of the electrically conductive portions 201 may be directly contactable or arranged in direct contact with a respective part of the aerosol generating component 100. For example, in FIG. 2, the at least one electrically conductive portion 201 comprises eight electrically conductive portions 201, and a section of each of these electrically conductive portions 201 is directly contactable or arranged in direct contact with a respective heating section 101. For example, in FIG. 4, the at least one electrically conductive portion 201 comprises eight electrically conductive portions 201, and a section of each of these electrically conductive portions 201 is directly contactable or arranged in direct contact with a respective heating section 101a, 101b. Similarly, in FIG. 8, the at least one electrically conductive portion 201 comprises eight electrically conductive portions 201, and a section of each of these electrically conductive portions 201 is directly contactable or arranged in direct contact with a respective heating section 101a, 101b.

In each of FIGS. 7 and 9, the aerosol generating material transfer component 200 comprises a single electrically conductive portion 201. Respective sections of this electrically conductive portion 201 may be directly contactable (as shown in FIG. 7) or arranged in direct contact with respective parts of the aerosol generating component 100 (as shown in FIG. 9).

As shown in FIGS. 2, 4, and 8, the at least one electrically insulating portion 202 may completely separate the electrically conductive portions 201. In this way, the at least one electrically insulating portion 202 may be arranged to intercept a current path between the respective parts of the aerosol generating component 100 via the aerosol generating material transfer component 200. In such an arrangement, a current path cannot traverse the respective parts via the aerosol generating material transfer component 200 without being intercepted by the at least one insulating portion 202. This may significantly reduce the risk of or prevent short circuiting between the respective parts via the aerosol generating material transfer component 200. For example, in FIG. 2, the aerosol generating material transfer component 200 comprises seven electrically insulating portions 202, and each electrically insulating portion 202 is layered between respective adjacent electrically conductive portions 201, such that respective adjacent electrically conductive portions 201 are completely separated by an electrically insulating portion 202. For example, in FIG. 4, the aerosol generating material transfer component 200 comprises seven electrically insulating portions 202 (not all are numbered), and each electrically insulating portion 202 is layered between respective adjacent electrically conductive portions 201 (not all are numbered), such that respective adjacent electrically conductive portions 201 are completely separated by an electrically insulating portion 202. In FIGS. 8 (and 9), the aerosol generating material transfer component comprises a single electrically insulating portion 202, and sections of the electrically insulating portion 202 extend between respective adjacent electrically conductive portions 201, such that respective adjacent electrically conductive portions 201 are completely separated by the electrically insulating portion 202.

Such separation is not present in FIGS. 7 and 9. Rather, in some aspects, such as in FIGS. 7 and 9, the at least one electrically insulating portion 202 is arranged such that a current path between the respective parts via the aerosol generating material transfer component 200 is tortuous. For example, in FIGS. 7 and 9 the current path between the respective parts of the aerosol generating element 100 via the aerosol generating material transfer component 200 would be bridge-shaped (e.g. in FIG. 7, if the outermost heating sections 101 were displaced so as to contact the electrically conductive portion 201 to the left hand side and the right hand side of the electrically insulating portion 202, respectively).

In some aspects, the at least one electrically conductive portion 201 and the at least one electrically insulating portion 202 are arranged in alternating layers (e.g. as described above). For example, in FIG. 2, the four electrically conductive portions 201 and the three electrically insulating portions 202 are arranged in alternating layers. For example, in FIG. 4, the eight electrically conductive portions 201 (not all are numbered) and the seven electrically insulating portions 202 (not all are numbered) are arranged in alternating layers. The layers may alternate along an axis (e.g. a longitudinal axis or transverse axis) of the aerosol generating material transfer component 200.

The aerosol generating component 100 is configured to generate aerosol from an aerosolisable material by heating. For example, the heating sections 101 are configured to generate aerosol from an aerosolisable material by heating.

The aerosol generating component 100 may comprise a first electrical connector 103 and a second electrical connector 104. The electrical connectors 103, 104 may take any form which permits electrical connection with an electrical contact. For example, the electrical connectors 103, 104 may simply touch an electrical contact to form the electrical connection, or may comprise securing means for secure connection to an electrical contact. Each electrical connector 103, 104 may be arranged at a respective end of the aerosol generating component 100.

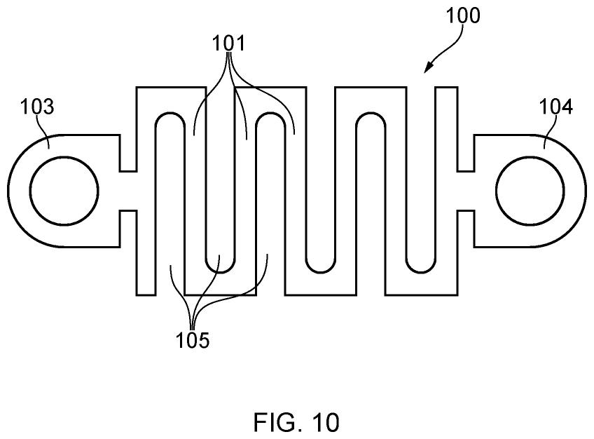

The aerosol generating component 100 may comprise at least one elongate aperture 105 (see FIG. 10), such as a plurality of elongate apertures. Herein, “aperture” requires a through-hole. The elongate apertures 105 may be spaced apart from each other. For example, the elongate apertures 105 may be spaced apart from each other along an axis (e.g. the longitudinal axis) of the aerosol generating component 100. The elongate apertures 105 may be arranged in parallel with each other. The elongate apertures may be slots or slits. The elongate apertures 105 may be open at a periphery of the aerosol generating component 100.

The aerosol generating component 100 (e.g. the heating sections 101) is configured to be heated to an aerosolisation temperature for aerosolising aerosolisable material.

In some aspects (e.g. when there is direct contact between the at least one electrically conductive portion 201 and the respective parts of the aerosol generating component 100), the electrical resistance between the first electrical connector 103 and the second electrical connector 104 through only the aerosol generating component 100 is less than the electrical resistance between the first electrical connector 103 and the second electrical connector 104 via the aerosol generating material transfer component 200. In some aspects (e.g. when there is direct contact between the at least one electrically conductive portion 201 and the respective parts of the aerosol generating component 100), in use, the current path between the first electrical connector 103 and the second electrical connector 104 via the aerosol generating material transfer component 104 may be longer than the current path between the first electrical connector 103 and the second electrical connector 104 through only the aerosol generating component 100. In some aspects (e.g. when there is direct contact between the at least one electrically conductive portion 201 and the respective parts of the aerosol generating component 100), in use, the current path between the first electrical connector 103 and the second electrical connector 104 via the aerosol generating material transfer component 200 may be tortuous.

These concepts are illustrated in FIG. 9, in which the current path between the first electrical connector 103 and the second electrical connector 104 through only the aerosol generating component 100 is indicated by dotted arrow “A”, and the current path between the first electrical connector 103 and the second electrical connector 104 via the aerosol generating material transfer component 200 is indicated by dotted arrow “B”. The current path herein is the path of least electrical resistance through the aerosol generating component 100 only, or through the aerosol generating component 100 via the aerosol generating material transfer component 200.

Herein, “the electrical resistance between the first electrical connector 103 and the second electrical connector 104 through only the aerosol generating component 100 is less than the electrical resistance between the first electrical connector 103 and the second electrical connector 104 via the aerosol generating material transfer component 200” means the electrical resistance between the first electrical connector 103 and the second electrical connector 103 by way of a current path that traverses only the aerosol generating component 100 is less than the electrical resistance between the first electrical connector 103 and the second electrical connector 104 by way of any current path that traverses the aerosol generating material transfer component 200.

Herein, “between the first electrical connector 103 and the second electrical connector 104 via the aerosol generating material transfer component 200” may mean from the first electrical connector 103, through an upstream section of the aerosol generating component 100, through at least part of the aerosol generating material transfer component 200, through a downstream section of the aerosol generating component 100, to the second electrical connector. “Upstream” and “downstream” in this context are with respect to the direction of current flow.

The percentage decrease (X) from the electrical resistance between the first electrical connector 103 and the second electrical connector 104 through only the aerosol generating component 100, to the electrical resistance between the first electrical connector 103 and the second electrical connector 104 via the aerosol generating material transfer component 200, may be defined by the following formula:

$$X = 100 * ( ( {R}_{AGC} - {R}_{A G T C} ) / {R}_{AGC} )$$

wherein R_{AGC} is the electrical resistance between the first electrical connector 103 and the second electrical connector 104 through only the aerosol generating component 100, and R_{AGTC} is the electrical resistance between the first electrical connector 103 and the second electrical connector 104 via the aerosol generating material transfer component 200, wherein X is at least 5%.

X may be at least 6%, at least 7%, at least 8%, at least 9%, at least 10%, at least 12%, at least 14%, at least 16%, at least 18%, at least 20%, at least 25%, at least 30%, at least 35%, at least 40%, at least 45%, or at least 50%.

The aerosol generating component 100 may be substantially planar.

The aerosol generating component 100 may comprise or be formed of an electrically conductive material.

The aerosol generating component 100 may have an electrical conductivity at atmospheric pressure and 20° C. of at least 1×10⁵ S/m (Siemens per metre), at least 2×10⁵ S/m, at least 5×10⁵ S/m, at least 1×10⁶ S/m, at least 1.2×10⁶ S/m, at least 1.4×10⁶ S/m, or at least 1.4×10⁶ S/m.

The aerosol generating component 100 may be formed of a thermally conductive material.

The aerosol generating component 100 may have a thermal conductivity at atmospheric pressure and 20° C. of at least 1 W/mK (Watts per metre-Kelvin), at least 2 W/mK, at least 4 W/mK, at least 5 W/mK, at least 8 W/mK, at least 10 W/mK, at least 12 W/mK, at least 14 W/mK, or at least 15 W/mK.

The aerosol generating material transfer component 200 may be characterised by any features of the aerosol generating material transfer component 200 of an above aspect of the present disclosure.

In an aspect of the present disclosure, there is provided an article 30 for use as part of a non-combustible aerosol provision system 10, the article 30 comprising: an aerosol generating material transfer component 200 comprising at least one electrically conductive portion 201 and at least one electrically insulating portion 202; and an aerosol generating component 100 comprising a first electrical connector 103 and a second electrical connector 104; wherein the at least one electrically conductive portion 201 is directly contactable or arranged in direct contact with respective parts of the aerosol generating component 100, wherein when there is direct contact between the at least one electrically conductive portion 201 and the respective parts of the aerosol generating component 100, the electrical resistance between the first electrical connector 103 and the second electrical connector 104 through only the aerosol generating component 100 is less than the electrical resistance between first electrical connector 103 and the second electrical connector 104 via the aerosol generating material transfer component 200.

The aerosol generating material transfer component 200 may be characterised by any features of the aerosol generating material transfer component 200 of an above aspect of the present disclosure.

In an aspect of the present disclosure, there is provided a non-combustible aerosol provision system 10 comprising:
an article 30 comprising: an aerosol generating material transfer component 200 comprising at least one electrically conductive portion 201 and at least one electrically insulating portion 202; and an aerosol generating component 100; wherein the at least one electrically conductive portion 201 is directly contactable or arranged in direct contact with respective parts of the aerosol generating component 100, and wherein the at least one electrically insulating portion 202 is arranged to reduce the risk of or prevent electrical short circuiting between the respective parts of the aerosol generating component 100 via the aerosol generating material transfer component 200; and
a device 20 for connecting to the article 30 and delivering electrical power to the aerosol generating component 100, the device 20 comprising one or more of a power source and a controller.

The article 30 may be characterised by any features of the article 30 of an above aspect of the present disclosure.

In an aspect of the present disclosure, there is provided a non-combustible aerosol provision system 10 comprising:
an article 30 comprising: an aerosol generating material transfer component 100 comprising at least one electrically conductive portion and at least one electrically insulating portion; and an aerosol generating component 100 comprising a first electrical connector 103 and a second electrical connector 104; wherein the at least one electrically conductive portion is directly contactable or arranged in direct contact with respective parts of the aerosol generating component, wherein when there is direct contact between the at least one electrically conductive portion 201 and the respective parts of the aerosol generating component 100, the electrical resistance between the first electrical connector 103 and the second electrical connector 104 through only the aerosol generating component 100 is less than the electrical resistance between first electrical connector 103 and the second electrical connector 104 via the aerosol generating material transfer component 200; and
a device 20 for connecting to the article 30 and delivering electrical power to the aerosol generating component 100, the device 20 comprising one or more of a power source and a controller.

The device may be arranged to at least partially receive the article 30. For example, the device may comprise an opening for receiving the article 30.

The article 30 may be characterised by any features of the article 30 of an above aspect of the present disclosure.

Any aspect of the present disclosure may be defined in relation to any of the other aspects of the present disclosure. For example, one aspect of the present disclosure may include any of the features of any other aspect of the present disclosure. For example, the features of one aspect of the present disclosure may be as defined in relation to the features of any other aspect of the present disclosure.

The figures herein are schematic and not drawn to scale. The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol generating component for use as part of an aerosol provision system, the aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component.

2. An aerosol generating component according to claim 1, wherein the axis defined by the aerosol generating component is selected from: the longitudinal axis of the aerosol generating component, the transverse axis of the aerosol generating component, and the axis of the aerosol generating component along which air flows in use.

3. An aerosol generating component according to claim 1, wherein the heating sections comprise a series of heating sections obliquely angled with respect to the axis defined by the aerosol generating component towards a direction.

4. An aerosol generating component according to claim 3, wherein the heating sections comprise a first series of heating sections obliquely angled with respect to the axis defined by the aerosol generating component towards a first direction; and a second series of heating sections obliquely angled with respect to the axis defined by the aerosol generating component towards a second direction.

5. An aerosol generating component according to claim 4, wherein the first direction is opposite from the second direction.

6. (canceled)

7. An aerosol generating component according to claim 1, wherein the oblique angle of a heating section closer to an end of the aerosol generating component, is different from the oblique angle of a heating section further from an end of the aerosol generating component.

8. An aerosol generating component according to claim 1, wherein the oblique angle of a heating section closer to an end of the aerosol generating component, is less than the oblique angle of a heating section further from an end of the aerosol generating component.

9. An aerosol generating component according to claim 1, wherein the oblique angles of the heating sections progressively decrease with increasing proximity of the heating section to an end of the aerosol generating component.

10. An aerosol generating component according to claim 1, wherein the aerosol generating component is generally planar, wherein the plane of the aerosol generating component is the plane of best fit through the aerosol generating component.

11. An aerosol generating component according to claim 1, wherein the aerosol generating component is formed from a single layer.

12. An aerosol generating component according to claim 1, wherein the aerosol generating component is an electrically resistive heating element.

13. An aerosol generating component according to claim 1, wherein the aerosol generating component is an induction heating element.

14. An aerosol generating component according to claim 1, wherein the aerosol generating component is formed of a metallic material.

15. An article for use as part of an aerosol provision system, the article comprising:
a housing comprising an airflow channel; and
an aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component,
wherein the aerosol generating component is arranged in the airflow channel.

16. An article according to claim 15, wherein at least a portion of the airflow channel is substantially perpendicular to the plane of the aerosol generating component.

17. An article according to claim 15, wherein the article comprises an aerosol generating material transfer component.

18. An article according to claim 17, wherein the aerosol generating material transfer component is porous.

19. An article according to claim 17, wherein the aerosol generating material transfer component is arranged adjacent the aerosol generating component.

20. (canceled)

21. (canceled)

22. An aerosol provision system comprising:
an article comprising: a housing comprising an airflow channel; and an aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component, wherein the aerosol generating component is arranged in the airflow channel; and
a device for connecting to the article and delivering electrical power to the aerosol generating component, the device comprising a power source.

23. (canceled)

24. A method of manufacturing an aerosol generating component for use as part of an aerosol provision system, the aerosol generating component defining an axis and comprising a plurality of generally planar heating sections, wherein the heating sections are arranged along the axis defined by the aerosol generating component and spaced apart from each other, wherein the plane of each heating section is obliquely angled with respect to the axis defined by the aerosol generating component, the method comprising:
providing cuts in a substantially planar sheet to define a plurality of blanks; and
twisting the blanks to provide the plurality of generally planar heating sections.
